(19) United States
(12) Patent Application Publication
(10) Pub. No.: US 2014/0189534 A1
(43) Pub. Date: Jul. 3, 2014

(54) CUSTOMIZING SHARED WEB RESOURCE SNAPSHOTS

(71) Applicant: Google Inc., Mountain View, CA (US)

(72) Inventors: Sean Yaoxing LIU, Sunnyvale, CA (US); Doug SHERRETS, San Francisco, CA (US)

(73) Assignee: Google Inc., Mountain View, CA (US)

(21) Appl. No.: 13/731,529

(22) Filed: Dec. 31, 2012

(51) Int. Cl. G06F 3/01

(52) U.S. Cl. CPC G06F 3/01
USPC 715/753

(57) ABSTRACT

A computer-implemented method includes receiving from a user a reference to a web resource for sharing with others, and providing a portion of content generated based on the received reference to the web resource for display to the user. The method also includes receiving a user selection of a portion of the generated content based at least on the displayed portion of the generated content. The method also includes generating the snapshot based on the received user selection of the portion of the generated content, and providing, without further user intervention, a rendering including the reference to the web resource and the generated snapshot for sharing with the others. Systems and machine-readable media are also provided.

### BACKGROUND

Users of the Internet may share links to interesting web resource (e.g., blogs, articles, videos, music, or websites/web pages) with general Internet users or with a predetermined group of users (e.g., contacts at social networking sites). Certain social networking sites may provide the users with tools which allow the users to share such links more easily. For example, a social networking site may provide a user interface (UI) for sharing links in which a user enters a uniform resource locator (URL) of the web resource that he or she wishes to share, and the UI generates a thumbnail image associated with the URL, next to the URL that the user has entered. The thumbnail image shows an image of a portion of the destination of the URL or an image otherwise associated with the URL. In some instances, a limited number of thumbnails are generated from which the user may make a selection.

### SUMMARY

The subject technology relates to a computer-implemented method that includes receiving from a user a reference to a web resource for sharing with others, and providing a portion of content generated based on the received reference to the web resource for display to the user. The method also includes receiving a user selection of a portion of the generated content based at least on the displayed portion of the generated content. The method also includes generating the snapshot based on the received user selection of the portion of the generated content, and providing, without further user intervention, a rendering including the reference to the web resource and the generated snapshot for sharing with the others.

These and other aspects can include one or more of the following features. The method may include storing the generated snapshot for use when sharing the web resource with the others. Generating the snapshot based on the received user selection of the portion of the generated content may further include receiving a user comment for the selected portion of the generated content. Receiving the user comment for the selected portion of the generated content may also include overlaying the received user comment over the selected portion of the generated content.

Additionally, generating the snapshot based on the received user selection of the portion of the generated content may also include receiving an annotation for marking up the selected portion of the generated content. Receiving the annotation for marking up the selected portion of the generated content may also include overlaying the received annotation over the selected portion of the generated content.

Further, generating the snapshot based on the received user selection of the portion of the generated content may also include generating an image based on the received user selection of the portion of the generated content and generating the snapshot based on the generated image. The method may also include associating the generated snapshot and the generated image such that the generated image is accessible based on the generated snapshot.

The method may further include generating a text snippet for sharing with the generated snapshot, the text snippet comprising text associated with the web resource, and the rendering may further include the generated text snippet. The step of generating the text snippet may include determining a portion of text of the web resource that is most relevant to the user, and generating the text snippet based on the determined text of the web resource. The step of generating the text snippet may also include determining a portion of text of the web resource that other users have selected for use as text snippets, and generating the text snippet based on the determined text of the web resource.

The method may further include suggesting to the user a default portion of the generated content for use as the snapshot, where the default portion is determined based on interactions of the other users with the suggested, default portion, and where the received user selection is based on the suggested default portion.

The subject technology further relates to a system that includes a memory storing executable instructions and a processor coupled to the memory configured to execute the stored executable instructions to receive, from a server, a web resource including content associated with the web resource, wherein the content is generated based on a reference to the web resource that is communicated to the server. The processor is further configured to provide the received web resource including the generated content for display to a user, receive a user selection of a portion of the displayed content, and communicate the received user selection to the server. The processor is further configured to receive a snapshot from the server, wherein the snapshot is generated based on the user selection that is communicated to the server, and provide, without further user intervention, the received snapshot for sharing the web resource with others.

These and other aspects can include one or more of the following features. The snapshot may be generated based on an image that is generated based on the user selection that is communicated to the server. The generated snapshot may be associated with the generated image such that the generated image is accessible based on the generated snapshot. The received snapshot may be shared along with the reference to the web resource.

The processor may be further configured to execute the stored instructions to receive from the server a text snippet for sharing with the generated snapshot, the text snippet including text associated with the web resource, where the step of providing the received snapshot for sharing comprises providing the received snapshot and the received text snippet for sharing with others. The text snippet may be generated based on a determination of a portion of text of the web resource that is most relevant to the user. The text snippet may also be generated based on a determination of a portion of text of the web resource that other users have selected for use as text snippets.

The disclosed technology also relates to a machine-readable storage medium comprising instructions stored therein, which when executed by processors, cause the processors to perform operations including receiving, from a web browser, a link to a web page for sharing on a social networking site, wherein the link is provided by a user of the social networking site. The operations also include generating content associated with the web page based on the received link, providing the web page including the generated content to the web browser for display to the user, and receiving, from the web browser, a user selection of a portion of the displayed web page. The operations further include generating a snapshot based on the received user selection, and communicating the generated snapshot to the web browser for sharing the web resource with others.

These and other aspects may provide one or more of the following advantages. Users may efficiently customize the thumbnail images or snapshots that are shared with references to web resources, such that the users may efficiently convey desired information in the thumbnail images or snapshots that is more relevant to the shared web resource.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purposes of explanation, several aspects of the subject technology are set forth in the following figures.

FIG. 1 illustrates an example architecture for customizing shared web resource snapshots.

FIG. 2 is a block diagram illustrating an example system for customizing shared web resource snapshots.

FIG. 3A is a diagram illustrating example operations for customizing shared web resource snapshots.

FIG. 3B shows diagrams illustrating different phases of operations for customizing shared web resource snapshots.

FIG. 4 illustrates an example flow diagram of example processes for customizing shared web resource snapshots.

FIG. 5 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, structures and components are shown in block diagram form in order to avoid obscuring the concepts of the subject technology.

According to various aspects of the subject technology, a method and system for customizing shared web resource snapshots is provided. When sharing a reference, or link (e.g., URL), to a web resource (e.g., entering a link at a sharing UI), users can take a screenshot of the web resource to be used as a snapshot which accompanies the shared link. A snapshot of the selected web resource may be generated by, for example, drawing a box on a portion of a screen of a client terminal or otherwise highlighting or selecting a portion of the web resource. According to one aspect, the drawn box may designate a portion of the screen which is captured in the screenshot. The screenshot is used as the snapshot when the web resource associated with the URL is shared. Users can also overlay additional commentary on top of the snapshot to further customize or annotate the snapshot. A “text snippet,” text which describes the web resource associated with the URL, may accompany the snapshot when the link to the web resource is shared with others.

When the user enters a link to a web resource the user wishes to share at the sharing UI, the web resource referenced by the link is fetched by the system. Upon fetching the referenced web resource, content associated with the fetched web resource is generated and displayed to the user. For example, when a user accesses a social networking site from a client terminal running a computer application capable of accessing the social networking site (e.g., web browser or smart phone application) and enters a URL of a web page to share in a sharing UI provided by the client terminal, a server (e.g., server of the social networking site or a third party server) fetches the web page and renders the web page at the server. Also, information such as the title of the web page and a short description of the web page may be extracted from the fetched web page. The rendered web page and the extracted information are then communicated to the user's client terminal for displaying to the user.

Once the rendered web page is displayed to the user at the client terminal, the user selects an area of the displayed web page that the user wishes to use as a snapshot for the web page when the URL of the web page is shared. According to one aspect of the disclosed subject matter, to select an area of the displayed web page, a “light box” may be provided in which the user may draw a box of an arbitrary size anywhere on the displayed web page, for the content within the box to be used as the snapshot. The portion of the web page outside of the drawn box remains dark, indicating that the dark portion is not a part of the snapshot, and the portion inside the drawn box is bright, indicating that the bright portion is a part of the snapshot.

When the area of the displayed web page that the user wishes to use as the snapshot has been selected by the user, the user may enter custom comments in the selected area. The selected area and any custom comments received for the selected area are sent to a server to be used as the snapshot. At the server, the selected area and any custom comments that are entered into the selected area are flattened or merged, to generate a single flattened image which includes both the selected area and the custom comments.

The flattened image may be too large (in terms of the dimensions of the image and in terms of its file size) to be suitable for sharing, and thus may not be suitable to be used as the snapshot. Therefore, at a server, the snapshot may be generated by either reducing the dimensions of the flattened image, reducing the file size (e.g., by compressing the flattened image or lowering its resolution), or both. The generated snapshot may be stored at, for example, at a database of the user's social networking site. The flattened image may also be stored in an image data store such as, for example, the database of the social networking site in which the snapshot is shared, or a database of an independent photo sharing site. The generated snapshot may contain a link to the flattened image such that users may click on the snapshot to access the full, larger version of the snapshot. The generated snapshot may be sent to the client terminal so that the user may view the result and decide whether or not to use the generated snapshot for sharing the web resource. When sharing the web resource using the generated snapshot, a post (e.g., a post on the user's social networking site) for sharing the web resource may be automatically generated using the generated snapshot, without further user intervention.

Text snippet which describes the shared web resource may also be generated and shared with the generated snapshot. The text snippet may be generated based on information such as the title of the web resource or a short description of the web resource that may be extracted from the shared web resource. The text snippet may also be generated based on the content of the snapshot.

While the disclosed subject matter is discussed in the context of generating snapshots of web pages, the disclosed subject matter may also apply to other types of web resources such as, for example, videos and images. The disclosed subject matter is discussed also in the context where different steps are performed at different entities (e.g., a client terminal and a server). For example, the discussion of the disclosed subject matter describes that a link to a web resource is received at a client terminal, whereas the web resource associated with the link is fetched and rendered at a server. However, the different steps of the disclosed subject matter may be performed entirely at a single entity. For example, the steps may be performed entirely at a client terminal, or entirely at a server).

The term “rendering” as used herein encompasses its plain and ordinary meaning, including, but not limited to, converting web resources to formats that are suitable for displaying or printing.

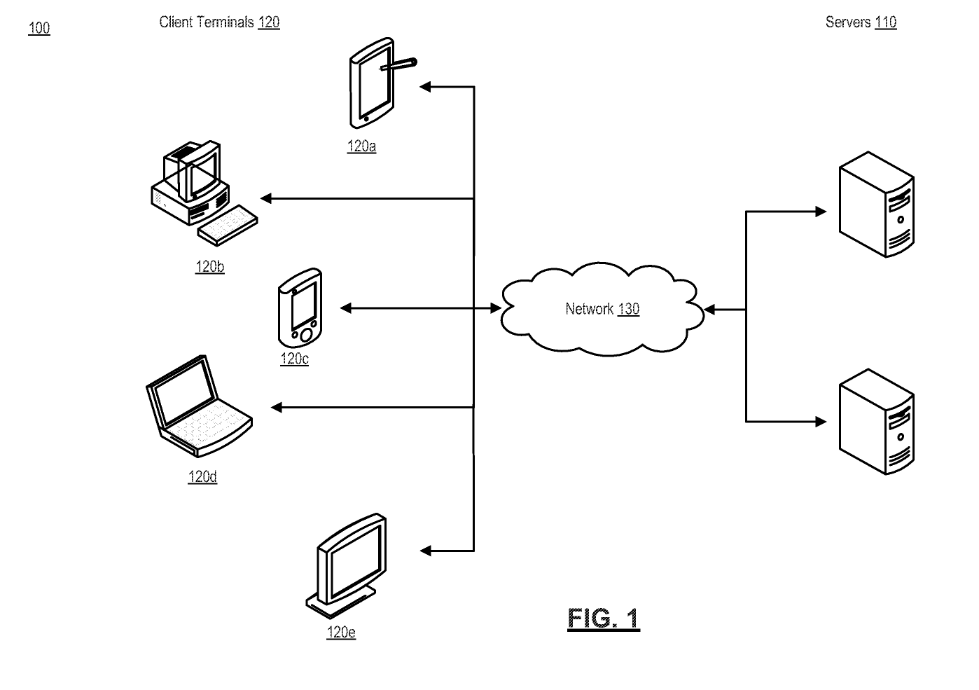

FIG. 1 illustrates an example architecture 100 for customizing shared web resource snapshots. The architecture 100 includes servers 110 and client terminals 120 connected over a network 130. Each of the client terminals 120 may interact with users and communicate with the servers 110 to customize shared web resource snapshots. The client terminals 120 may be, for example, mobile devices such as tablet computers 120a, desktop computers 120b, smart phones 120c, laptop computers 120d, or navigation systems 120e that are capable of running computer applications (e.g., web browser or mobile applications) for accessing the Internet. The client terminals 120 may, for example, receive a reference to a web resource, display the web resource including content associated with the web resource, and receive, from a user, a selection of a portion of the displayed content which may be used in generating a snapshot.

The servers 110 may be any device having a processor, memory, and communications capabilities for communicating with the client terminals 120 to exchange data for customizing shared web resource snapshots. The servers 110 may be a single server, or may be two or more servers communicating with each other to provide the functionalities for customizing shared web resource snapshots. For example, the servers 110 may be multiple servers arranged in a cloud computing configuration. The servers 110 may, for example, receive the user selection of the portion of the displayed content from the client terminals 120, and generate a snapshot based on the received user selection.

The network 130 may include, for example, any one or more of a personal area network (PAN), a local area network (LAN), a campus area network (CAN), a metropolitan area network (MAN), a wide area network (WAN), a broadband network (BBN), the Internet, and the like. Further, the network 130 can include, but is not limited to, any one or more of the following network topologies, including a bus network, a star network, a ring network, a mesh network, a star-bus network, tree or hierarchical network, and the like.

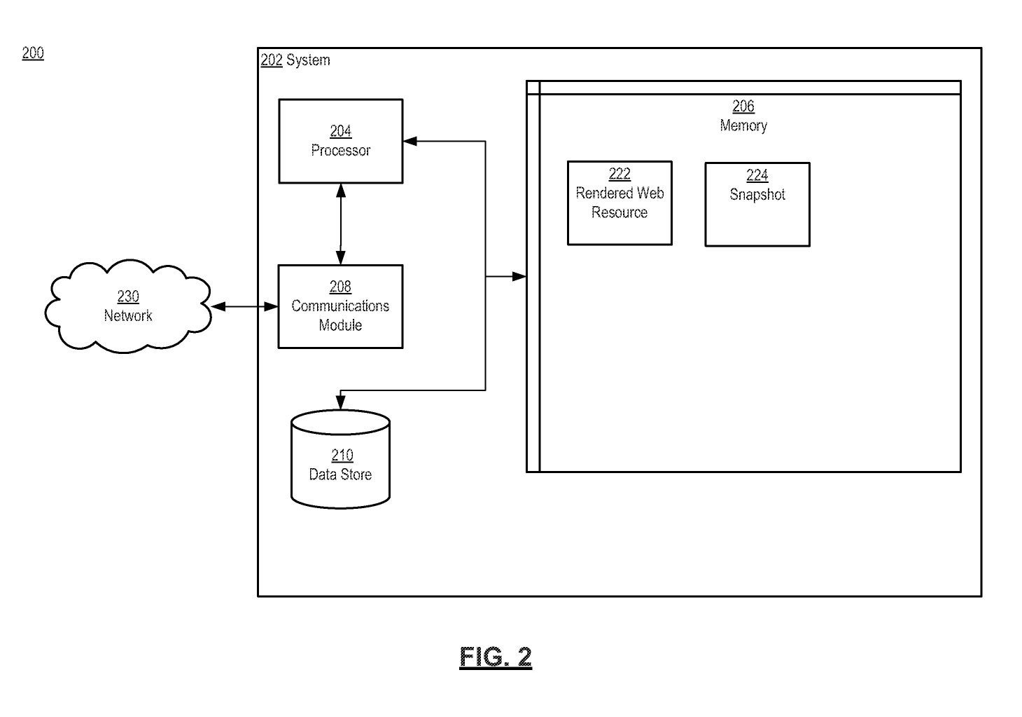

FIG. 2 is a block diagram 200 illustrating an example system 202 for customizing shared web resource snapshots. The system 202 may be implemented, for example, at one of the client terminals 120a-120e, at one of servers 110, or spread across servers 110 and client terminals 120a-120e. The system 202 includes a processor 204 and a memory 206. The system 202 also includes a communications module 208, and is connected to a network 230 via the communications module 208. The network 230 may be, for example, the network 130 of FIG. 1. The communications module 208 is configured to interface with the network 230 to send and receive information, such as data, requests, responses, and commands to other devices (e.g., servers 110 or client terminals 120a-120e) or systems on the network 230. The communications module 208 may be, for example, modems. Ethernet cards or mobile broadband adaptors.

The memory 206 includes a rendered web resource 222 and a snapshot 224. A user may provide the system 202 with a reference (e.g., a hyperlink, URL, or other types of links) to web resource (e.g., a web page, video clip, music, or image) that he or she wishes to share, and the system may fetch and render the web resource to generate content associated with the web resource. The generated content may be, for example, the rendered web resource 222. The snapshot 224 is generated based on user's selection of a portion of the rendered web resource 222. For example, the user may select a portion of the rendered web resource 222 which he or she wishes to display with the reference to the web resource.

System 202 may also include a data store 210, which may also store the rendered web resource 222 and the snapshot 224. The data store 210 may be integrated with the memory 206, or may be independent from the memory and be in communication with the processor 204 and the memory. The data store 210 may also be implemented to be independent from the system 202 and in communication with the system.

The processor 204 is configured to execute instructions, such as instructions physically coded into the processor, instructions received in the form of software from the memory 206, or a combination of both. For example, the processor 204 is configured to execute instructions to provide for display to a user a web resource including the rendered web resource 222, in response to receiving a reference to the web resource. The processor 204 is also configured to receive from the user a selection of a portion of the rendered web resource 222. The processor 204 is further configured to generate a snapshot 224 based on the received selection of the portion of the rendered web resource, and share the generated snapshot on the Internet.

The processor 204 may also receive a comment for overlaying the selected portion of the rendered web resource, and generate the snapshot 224 based on the selection and the received comment. The processor 204 may also receive annotations for overlaying the selected portion of the rendered web resource, and generate the snapshot 224 based on the received selection and the received annotation. When generating the snapshot 224, the processor 204 may be configured to first generate an image, and then generate the snapshot which is smaller in size than the image. The snapshot 224 may contain information that is substantially identical to the image that is first generated. The image that is first generated may be stored in an image data store (not shown) which is different from the memory 206 or the data store 210. The image data store may also store the generated snapshot 224.

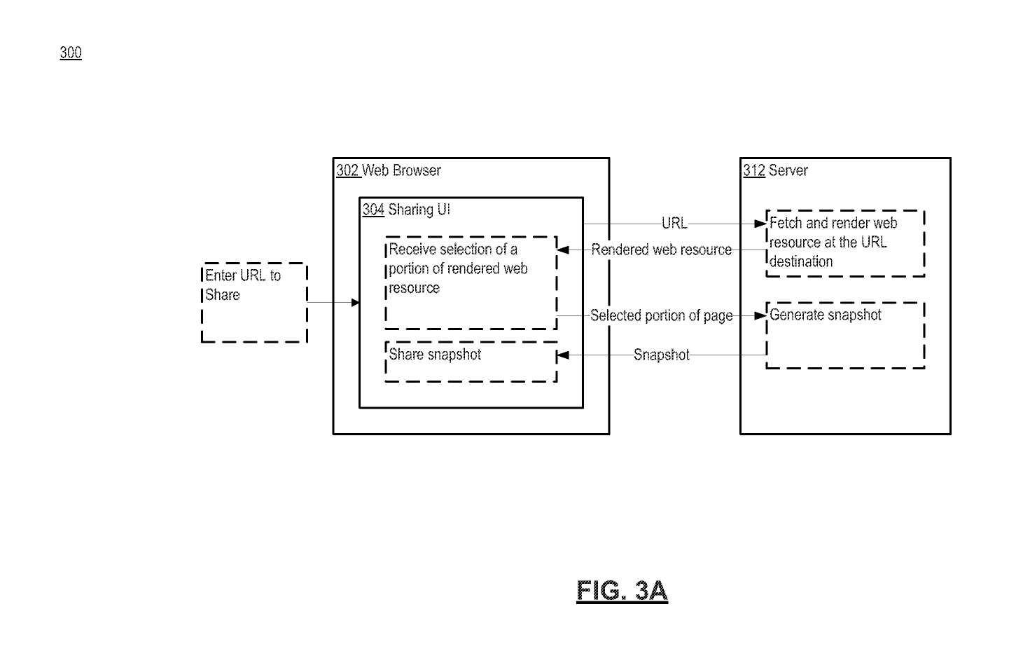

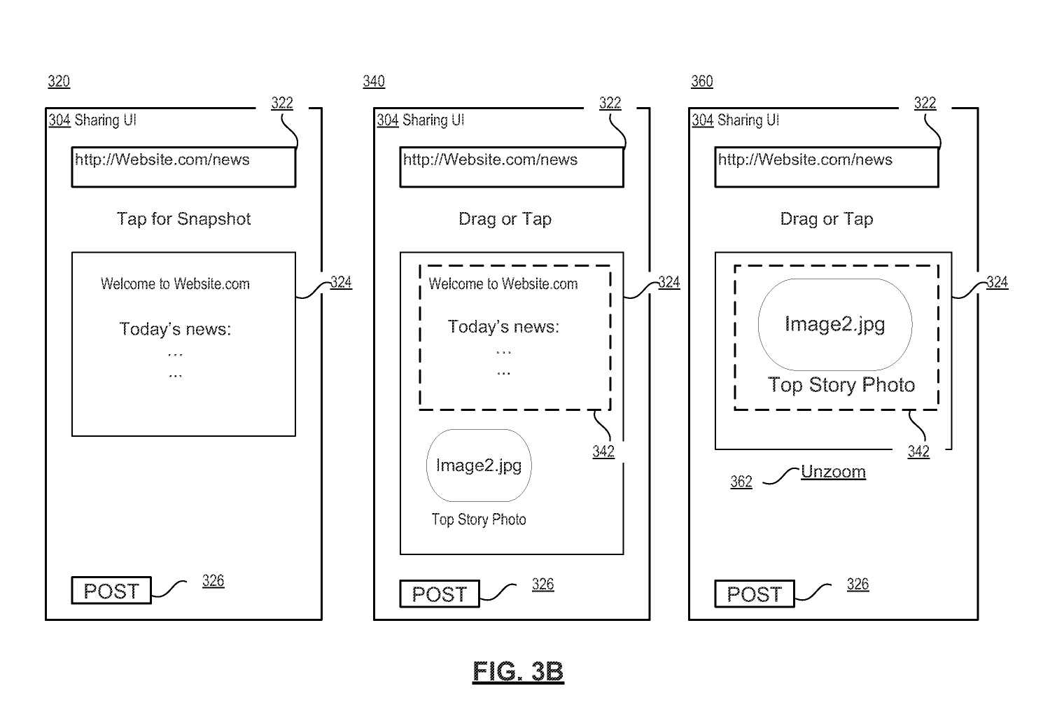

FIG. 3A is a diagram 300 illustrating example operations for customizing shared web resource snapshots. The operations may be performed, for example, by the system 202. Diagram 300 shows a web browser 302 in communication with server 312 (e.g., servers 110). The web browser 302 may be, for example, an application running on a client terminal (e.g., client terminals 120a-120e). While diagram 300 illustrates a web browser 302, the operations described with reference to FIG. 3A may also apply to other types of computer applications, for example, mobile applications. Further, while diagram 300 describes operations which are performed by the web browser 302 and the server 312 which are in communication with each other, the entire operations may be performed at a single entity, for example, entirely at the web browser 302 or entirely at the server 312.

A reference, or a link (e.g., a URL or a hyperlink), to web resources that a user wishes to share may be received at a sharing UI 304 provided at the web browser 302. The sharing UI 304 may be a UI which facilitates sharing web resources with other users on the Internet. For example, the sharing UI 304 may include a box for entering a URL to web resources such as blogs, articles, music, videos, or image files that a user wishes to share with other users of a social networking site. According to one aspect of the disclosed technology, after the URL is received at the sharing UI 304, the URL is communicated to the server 312. The server 312 fetches the web resource residing at the destination of the URL, and renders the web resource. For example, if the web resource residing at the destination of the URL is a web page, the web page is fetched and rendered. The rendered web resource is communicated to the web browser 302 and displayed to the user.

The sharing UI 304 may also include UI elements which display the rendered web resource, and may also include features which facilitates user's generation of a snapshot which may be shared along with the URL of web resource that the user wishes to share. For example, the sharing UI 304 may contain a UI element which allows the user to view the rendered web resource and select an area of the rendered web resource to be used as a snapshot which represents the shared web resource. Specifically, the sharing UI may include one or more features that allow the user to select an area to be used as the snapshot by drawing a circle, ellipse, polygon, or other type of closed loop on the displayed web resource. The sharing UI may also include one or more took for zooming in, zooming out or moving the displayed rendered web resource. The area selected for use as the snapshot (e.g., inside the closed loop) may be displayed brighter than the portions outside the selected area, such that the selected area may be easily identified.

In an aspect of the subject technology, the sharing UI 304 suggests a default area of the rendered web resource for use as the snapshot. For example, after the web browser 302 receives the rendered web resource from the server 312, the sharing UI displays to the user a default area of the rendered web resource that the user may select as the area to be used as the snapshot. The default area may be displayed, for example, in a predetermined portion of the sharing UI for displaying the snapshot. The default area may be, for example, the top portion of the rendered web resource, an area of the rendered web resource including an image that is determined to be relevant to the user, an image that is determined to be unique to the rendered web resource compared to the rest of website which the rendered web resource is part of and/or the web, or a dominant image included in the rendered web resource. Text suggested for use as the text snippet which may be shared with the snapshot may also be displayed. The suggested text may be, for example, the title of the rendered web resource, text of the rendered web resource that is determined to be most relevant to the user, or text of the rendered web resource that other users of the Internet have selected as text snippets for use when sharing the rendered web resource.

The default area suggested for use as the snapshot may be a zoomed-in part of the rendered web resource, depending on a screen size on which the suggested default area may be displayed. The zoomed-in part of the rendered web resource may include a prominent image that is large enough such that the image provides sufficient context for determining the general content of the rendered web resource, given the screen size of the device on which the suggested default area is displayed. For example, if web resource is shared from a mobile device (e.g., a smart phone or a tablet computer), the default area suggested for the snapshot may be an image of the rendered web resources that is more zoomed-in as compared to when the web resource is shared from a desktop, to account for the smaller screen size of the mobile device. Alternatively, an area of a mobile version of the rendered web resource may be suggested for use as the snapshot, and the user may accept the suggested default area or take another snapshot from the mobile version of the rendered web resource.

The default area suggested for use as the snapshot may be based on selections by other users and/or the following views/activity/feedback analytics on the selections by the other users, such as, for example, suggesting a snapshot selection that users tended to use given the number of views on the web resource, suggesting an image based on a number of shares that were made for the image, including the number of shares for the specific image URL as well as other images that are similar, or suggesting a selection of text based on popularity of excerpts of text that are highlighted by users using tools and/or additional resources such as users copy-and-pasting text into other posts. The suggested area for use as a snapshot may be displayed to the user when the user selects to share a reference to web resource (e.g., URL) by clicking/tapping on the reference to access the sharing UI (e.g., sharing UI 304), with the ability to edit the suggested area or select a new area for use as the snapshot.

The sharing UI may also include one or more features that allow the user to either accept the suggested default area for use as the snapshot, or change the suggested default area to select another area of the rendered web resource to be used as the snapshot. For example, if the user wishes to change the suggested default area, the user may click/tap or otherwise select the suggested default area of the rendered web resource to enter a “selection mode.” in the selection mode, the user is provided with one or more tools to zoom in, zoom out, or move the displayed rendered web resource and select a desired area of the rendered web resource as discussed above. In the selection mode, any references or links that may be included in the rendered web resource is removed or deactivated such that the user may interact with the rendered web resource without unintentionally requesting another web resource referenced by such references or links.

The suggested text for use as the text snippet may also change according to the area selected for use as the snapshot. For example, the suggested text for the text snippet may be automatically updated by using the text around or inside the area of the rendered web page selected by the user. The user may also select the text for use as the text snippet independently from selecting the area of the rendered web resource for use as the snapshot.

When the user selects the area to be used as the snapshot, the user may also provide comments to be overlaid on top of the selected area. The comments provided by the user may include text or graphical annotations. For example, the user may type in text which provides additional information associated with the selected area, or draw mark-ups onto the selected area. The additional information on the selected area, along with any comments or annotations to be overlaid on top of the selected area, is communicated to the server 312. Based on the additional information communicated to the server 312, a snapshot is generated which may be shared along with the URL of the web resource that the user wishes to share. The snapshot may be presented to the user, who may select the snapshot for sharing along with the web resource.

In generating the snapshot, the selected area of the rendered web resource and any comments are merged into a single flattened image. From the flattened image, the snapshot is generated. The snapshot may be substantially identical to the flattened image of the rendered web resource, but may be smaller in storage size and/or in image dimensions, such that the snapshot takes up less storage space as compared to the flattened image. A smaller snapshot may be shared more easily with others.

The flattened image of the rendered web resource may be stored in a dedicated image data store. Association may be made between the flattened image and the snapshot generated from the flattened image, such that when a user wishes to access a full version of the generated snapshot, the user may easily access the flattened image through the snapshot. For example, the snapshot may embed a link, or may be shared with a link to the flattened image stored in the dedicated image server such that a user who wishes to access the full version of the snapshot may click on the snapshot to access the flattened image. According to an aspect of the subject disclosure, a recipient of the shared link may also be able to access the flattened image.

The generated snapshot may be communicated to the web browser 302 for displaying to the user. The user may view the snapshot and decide whether to accept the snapshot to be used when sharing the URL of the web resource or to generate a new snapshot. Alternatively, the generated snapshot may be automatically shared with others, along with the URL of the web resource.

When sharing the URL of the web resource and the generated snapshot, a post for sharing on the user's social networking site may be automatically generated which includes the generated snapshot and the reference to the web resource, without further user intervention. The post may be, for example, a rendering (e.g., an image) that includes the generated snapshot and the URL of the web resource that may be shared with other users of the social networking site. The snapshot that is generated based on user selection, as discussed above, allows a user to identify an area of the shared web resource on which the user wishes the recipients of the shared web resource to focus.

FIG. 3B shows diagrams 320-360 illustrating the sharing UI 304 during different phases of operations for customizing shared web resource snapshots described with reference to FIG. 3A. Diagram 320 of FIG. 3B shows an example view of the sharing UI 304 after the user has entered a URL of a web resource and default area of the rendered web resource is suggested to the user for use as the snapshot. Diagram 320 shows a URL 322 of the rendered web resource, a UI 324 for selecting an area of the rendered web resource to be used as a snapshot, and a post button 326. The UI 324 of diagram 320 displays the default area of the rendered web resource that is suggested be used as the snapshot. If the user wishes the accept the suggested default area for use as the snapshot to share with the URL 322, the user can click or tap on the button 326 to proceed with generating the snapshot to share with other users. If the user wishes to select another area of the rendered web resource as the snapshot, the user may click or tap on the UI 324 to enter into the selection mode.

Diagram 340 shows the sharing UI 304 in the selection mode. In the selection mode, the UI 324 expands to display a larger area of the rendered web page than in diagram 320. Also, a selector 342 for selecting the area of the rendered web resource to be used as the snapshot, appears in the UI 324. The selector 342 marks the boundary of the selected area of the rendered web resource for use as the snapshot. Initially, the selector 342 selects the suggested default area of the rendered web resource. The user may select the area of the rendered web resource for use as the snapshot by moving the selector 342 or adjusting the boundaries of the selector 342. For example, dragging (e.g., clicking/tapping-and-holding, and then moving the mouse/finger in a desired direction while holding) from inside the selector 342 allows the user to move the selector. Dragging at the boundaries of the selector 342 allows the user to adjust the selector's boundaries.

The user may also move or scroll the rendered web resource by dragging on the displayed rendered web resource from outside the selector 342. When dragging from outside the selector 342, the selector 342 moves or scrolls with the rendered web resource. The user may also zoom in or zoom out to a particular area of the rendered web resource by clicking/tapping or clicking/tapping-and-holding. In an aspect of the subject technology, in case where the user clicks or taps on an image included the rendered web resource, the UI 324 zooms in/out to fit the entire image and any additional context on the rendered web resource associated with the image, in the UI 324. In such case, the selector 342 also automatically moves to select the entire image and its associated context.

Diagram 360 shows the sharing UI 304 where the user has selected an image and additional context associated with the image. The UI 324 has zoomed into the image and its associated context, and the selector 342 has automatically selected the image and the context. The user may click/tap the “unzoom” button 362 to go back to the previous view (e.g., diagram 340), or may click/tap the post button 326 to accept the selection and proceed with generating the snapshot for sharing with others.

The “unzoom” button 362 may appear any time the user has zoomed into a particular area of the rendered web resource. Also, by clicking/tapping on the post button 326, the user may choose to generate the snapshot for sharing with others at different phases of operations for customizing shared web resource snapshots, including, but not limited to, when a default area of the rendered web resource is suggested to the user for use as the snapshot (e.g., as discussed with reference to diagram 320), when the user makes a first custom selection (e.g., as discussed with reference to diagrams 340 and 360), or after making further adjustments.

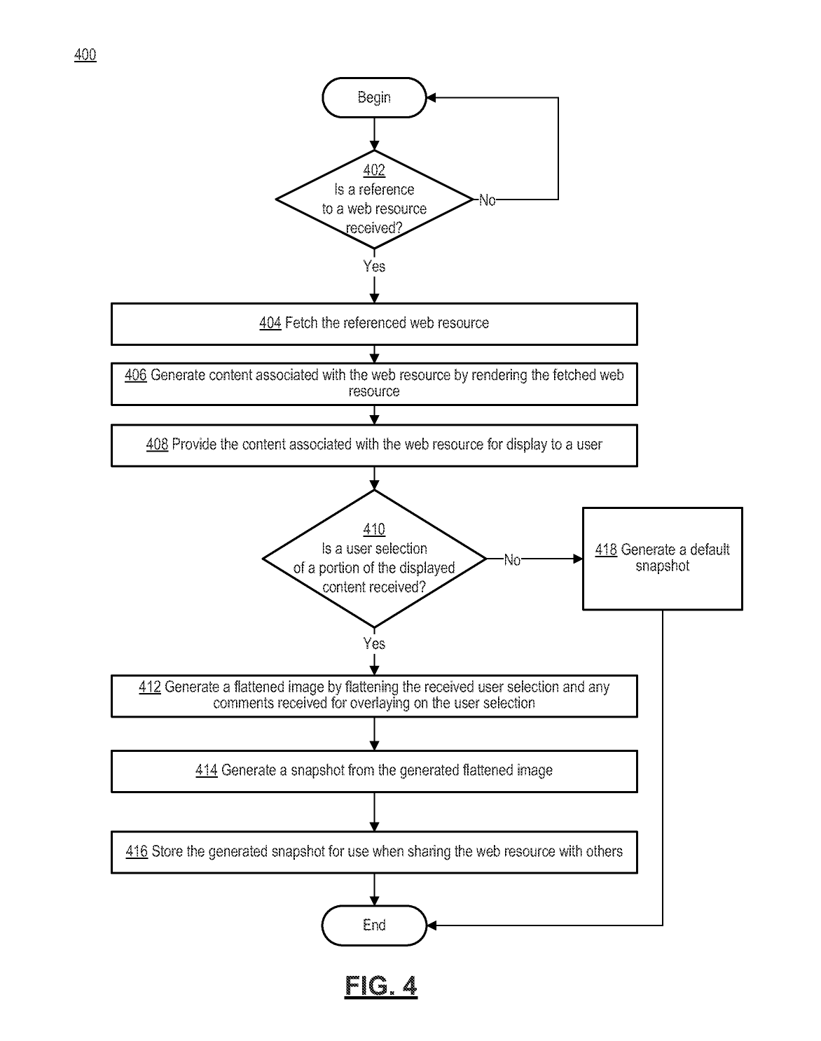

FIG. 4 illustrates a flow diagram of example processes 400 for customizing shared web resource snapshots. The processes of FIG. 4 may be performed by, for example, system 202. However, the operations of FIG. 4 are not limited to such a system, and may be performed using other systems/configurations.

Process 400 begins at block 402 where determination is made whether a reference (e.g., a hyperlink) to a web resource to share with others is received from a user. The reference to the web resource may be received, for example, at a sharing UI. The web resource for sharing may be, for example, a web page, image, video clip, or music. When a reference to a web resource for sharing with others is received, at block 404, the referenced web resource is fetched from a destination of the reference to web resource. Such destination may be, for example, a server hosting the web resource. At block 406, content associated with the web resource is generated by rendering the fetched web resource for display to the user. At block 408, the content associated with the web resource is provided for display to the user. The original web resource that was fetched at block 404 may also be provided for display to the user, together with the content associated with the web resource. The contents associated with the web resource may be displayed at, for example, a client terminal (e.g., client terminals 120).

At block 410, a determination is made whether a selection of a portion of the displayed content is received from the user. As discussed above, the content associated with the web resources may be displayed at a client terminal of the user, and the client terminal may include a UI which allows the user the make a selection on the displayed content. The selection may be received by the user drawing a circle, ellipse, polygon, or another type of closed loop on the displayed content. In addition to receiving a selection of content to be used as the snapshot, user comments may be added to the selected content. The comments may include text comments or graphical annotations. When a selection of a portion of displayed content is received from the user, a flattened image is generated at block 412. The flattened image may be generated by flattening or merging the selected portion of displayed content together with any comments received for the selected portion. The flattened image may be stored at, for example, an image data store.

From the flattened image, a snapshot for sharing the web resource is generated at block 414. The snapshot may be smaller in storage size than the flattened image. The image dimensions of the generated snapshot may also be smaller than the flattened image. The generated snapshot may also include a link to the flattened image from which it was generated, such that a user may access the larger version of the snapshot. At block 416, the generated snapshot is stored for use when sharing the web resource with others. The stored snapshot may be shared with others on the Internet (e.g., on the user's social networking site) along with the reference to the web resource that is received at block 402. For example, when sharing the stored snapshot along with the reference to the web resource, a post for sharing on the user's social networking site may be automatically generated which includes the generated snapshot and the reference to the web resource, without further user intervention.

If no selection of a portion of the displayed content is received from the user at block 410, at block 418, a default snapshot is generated from the content associated with the web resource generated at block 406. The default snapshot may be a predetermined image or text such as, for example, an image of a predetermined portion of the content associated with the web resource generated at block 406, or a text which reads “no snapshot is available.”

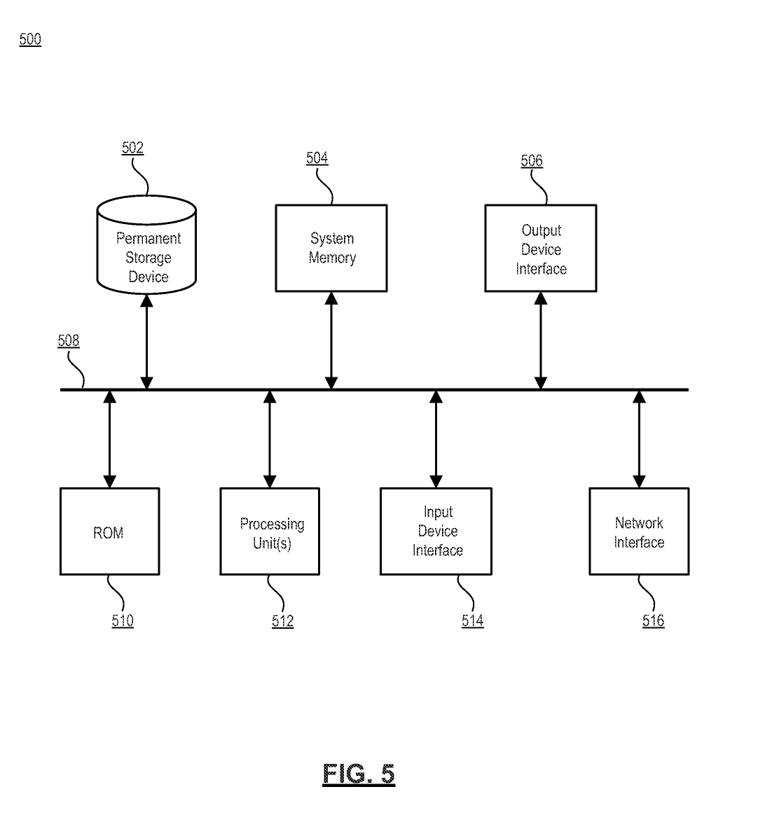

FIG. 5 conceptually illustrates an electronic system with which some implementations of the subject technology are implemented. Electronic system 500 can be a computer, phone, PDA, or any other sort of electronic device. Such an electronic system includes various types of computer-readable media and interfaces for various other types of computer-readable media. Electronic system 500 includes a bus 508, processing unit(s) 512 (e.g., processor(s)), a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502. From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such as a random access memory. System memory 504 stores some of the instructions and data that the processor needs at runtime. In some implementations, the processes of the subject disclosure are stored in system memory 504, permanent storage device 502, and/or ROM 510. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interface 506 enables, for example, the display of images generated by the electronic system 500. Output devices used with output device interface 506 include, for example, printers and display devices, such as cathode ray tubes (CRT) or liquid crystal displays (LCD). Some implementations include devices such as a touchscreen that functions as both input and output devices.

Finally, as shown in FIG. 5, bus 508 also couples electronic system 500 to a network (not shown) through a network interface 516. In this manner, the computer can be a part of a network of computers (such as a local area network (“LAN”), a wide area network (“WAN”), an Intranet, or a network of networks, such as the Internet. Any or all components of electronic system 500 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessors or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms “display” or “displaying” means displaying on an electronic device. As used in this specification and any claims of this application, the terms “computer-readable medium” and “computer-readable media” are entirely restricted to tangible, physical objects that store information in a form that is readable by a computer. These terms exclude any wireless signals, wired download signals, and any other ephemeral signals.

To provide for interaction with a user, implementations of the subject technology described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user.

Aspects of the subject technology described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject technology described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that not all illustrated steps be performed. Some of the steps may be performed simultaneously. For example, in certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

All structural and functional equivalents to the elements of the various aspects described throughout this disclosure that are known or later come to be known to those of ordinary skill in the art are expressly incorporated herein by reference and are intended to be encompassed by the claims.

What is claimed is:

1. A computer-implemented method comprising:
receiving from a user a reference to a web resource for sharing with others;
providing a portion of content generated based on the received reference to the web resource for display to the user;
receiving a user selection of a portion of the generated content based at least on the displayed portion of the generated content;
generating a snapshot based on the received user selection of the portion of the generated content; and
providing, without further user intervention, a rendering including the reference to the web resource and the generated snapshot for sharing with the others.

2. The computer-implemented method of claim 1, further comprising storing the generated snapshot for use when sharing the web resource with the others.

3. The computer-implemented method of claim 1, wherein generating the snapshot based on the received user selection of the portion of the generated content further comprises receiving a user comment for the selected portion of the generated content.

4. The computer-implemented method of claim 3, wherein receiving the user comment for the selected portion of the generated content comprises overlaying the received user comment over the selected portion of the generated content.

5. The computer-implemented method of claim 1, wherein generating the snapshot based on the received user selection of the portion of the generated content further comprises receiving an annotation for marking up the selected portion of the generated content.

6. The computer-implemented method of claim 5, wherein receiving the annotation for marking up the selected portion of the generated content comprises overlaying the received annotation over the selected portion of the generated content.

7. The computer-implemented method of claim 1, wherein generating the snapshot based on the received user selection of the portion of the generated content comprises generating an image based on the received user selection of the portion of the generated content and generating the snapshot based on the generated image.

8. The computer-implemented method of claim 7, further comprising associating the generated snapshot and the generated image such that the generated image is accessible based on the generated snapshot.

9. The computer-implemented method of claim 1, further comprising generating a text snippet for sharing with the generated snapshot, the text snippet comprising text associated with the web resource, wherein the rendering further includes the generated text snippet.

10. The computer-implemented method of claim 9, wherein the step of generating the text snippet comprises determining a portion of text of the web resource that is most relevant to the user, and generating the text snippet based on the determined text of the web resource.

11. The computer-implemented method of claim 9, wherein the step of generating the text snippet comprises determining a portion of text of the web resource that other users have selected for use as text snippets, and generating the text snippet based on the determined text of the web resource.

12. The computer-implemented method of claim 1, further comprising suggesting to the user a default portion of the generated content for use as the snapshot, wherein the default portion is determined based on interactions of the other users with the suggested, default portion; and
wherein the received user selection is based on the suggested default portion.

13. A system comprising:
a memory storing executable instructions; and
a processor coupled to the memory configured to execute the stored executable instructions to:
receive from a server a web resource including content associated with the web resource, wherein the content is generated based on a reference to the web resource that is communicated to the server;
provide the received web resource including the generated content for display to a user;
receive a user selection of a portion of the displayed content;
communicate the received user selection to the server;
receive a snapshot from the server, wherein the snapshot is generated based on the user selection that is communicated to the server; and
provide, without further user intervention, the received snapshot for sharing the web resource with others.

14. The system of claim 13, wherein the snapshot is generated based on an image that is generated based on the user selection that is communicated to the server.

15. The system of claim 14, wherein the generated snapshot is associated with the generated image such that the generated image is accessible based on the generated snapshot.

16. The system of claim 13, wherein the received snapshot is shared along with the reference to the web resource.

17. The system of claim 13, wherein the processor is further configured to execute the stored instructions to receive from the server a text snippet for sharing with the generated snapshot, the text snippet comprising text associated with the web resource, wherein the step of providing the received snapshot for sharing comprises providing the received snapshot and the received text snippet for sharing with others.

18. The system of claim 17, wherein the text snippet is generated based on a determination of a portion of text of the web resource that is most relevant to the user.

19. The system of claim 17, wherein the text snippet is generated based on a determination of a portion of text of the web resource that other users have selected for use as text snippets.

20. A machine-readable storage medium comprising instructions stored therein, which when executed by processors, cause the processors to perform operations comprising:
receiving, from a web browser, a link to a web page for sharing on a social networking site, wherein the link is provided by a user of the social networking site;
generating content associated with the web page based on the received link;
providing the web page including the generated content to the web browser for display to the user;
receiving, from the web browser, a user selection of a portion of the displayed web page;
generating a snapshot based on the received user selection; and
communicating the generated snapshot to the web browser for sharing the web resource with others.
